(19) United States
(12) Patent Application Publication
(10) Pub. No.: US 2016/0093230 A1
(43) Pub. Date: Mar. 31, 2016

(54) DOMELESS SIMULATOR

(71) Applicant: Lockheed Martin Corporation, Bethesda, MD (US)

(72) Inventors: Richard P. Boggs, Orlando, FL (US); Robin B. Schiro, Orlando, FL (US); Edward T. Grant, Orlando, FL (US); Patrick T. Goergen, Orlando, FL (US); Eric T. Sorokowsky, Winter Springs, FL (US)

(21) Appl. No.: 14/501,509

(22) Filed: Sep. 30, 2014

(51) Int. Cl. G09B 9/30

(52) U.S. Cl. CPC G09B 9/302; G09B 9/307

(57) ABSTRACT

A domeless simulator is disclosed. The simulator includes a head-mounted display device having a field-of-view (FOV) and a cockpit control surface. An image generation device is coupled to the head-mounted display device and configured to generate imagery of a virtual environment including an out-the-window image component and a cockpit control image component that is registered to the cockpit control surface. A hand track device is configured to sense a location of a hand of a user. A controller is coupled to the hand track device and is configured to determine the location of the hand with respect to the FOV.

### TECHNICAL FIELD

The embodiments relate generally to simulators, and in particular to a domeless simulator.

### BACKGROUND

Commercial simulators, such as flight simulators, are relatively large systems that require a substantial amount of space. A flight simulator, for example, may include a large dome on which imagery is projected, and may include multiple projectors and image generators, which are costly, require a substantial amount of power, and generate a substantial amount of heat, which in turn increases environmental cooling requirements. As an example, one known flight simulator utilizes 25 projectors and requires a dome that is 20 feet in diameter, and utilizes 314 square feet of space. Such size requirements can limit the locations at which the simulator can be used. The use of a dome may also require special focus adjustments to any heads-up display (HUD) apparatus used in the simulator to make the HUD apparatus focus at the distance of the dome, increasing simulator configuration complexity. Moreover, the physical cockpit controls used by the user are made as realistic as possible to ensure simulation realism, which further increases simulator costs.

### SUMMARY

The embodiments provide a domeless simulation system, sometimes referred to as a simulator, that utilizes a head-wearable display, a head track device, and a hand track device to realistically simulate an out-the-window display and an instrument control panel of a vehicle, such as an aircraft, to a user. Among other features, the embodiments visually depict in imagery movements of the user's hand manipulating virtual controls based on physical movements of the user's hand in a real-world environment.

In one embodiment, a simulator is provided. The simulator includes a head-mounted display (HMD) device having a field-of-view (FOV) and a cockpit control surface. An image generation device is coupled to the HMD device and configured to generate imagery of a virtual environment including an out-the-window image component and a cockpit control image component that is registered to the cockpit control surface. A hand track device is configured to sense a location of a hand of a user. A controller is coupled to the hand track device and is configured to determine the location of the hand of the user with respect to the FOV.

In one embodiment, the controller is further configured to cause the image generation device to insert a virtual hand into the imagery of the virtual environment at a virtual location that corresponds to a sensed location of the hand of the user.

In one embodiment, the controller is further configured to determine, based on the hand track device, a contact location on the cockpit control surface of the hand of the user, correlate the contact location with a virtual cockpit control of a plurality of virtual cockpit controls depicted in the cockpit control image component, and cause the image generation device to generate imagery depicting contact of the virtual cockpit control with the virtual hand.

In one embodiment, the controller is further configured to alter a vehicle motion characteristic, such as an altitude, velocity, or direction, based on the virtual cockpit control. The controller may also cause the image generation device to alter the imagery of the virtual environment in response to altering the vehicle motion characteristic.

In one embodiment, the simulator includes a head track device, and, based on head track data received from the head track device, the controller continuously determines the FOV of the HMD device. In one embodiment, the controller alters the imagery of the virtual environment in synchronization with a change in the FOV of the HMD device.

In one embodiment, over a period of time and based on the hand track device, the controller causes the image generation device to move the virtual hand with respect to the FOV in correspondence with a plurality of sensed locations of the hand of the user over the period of time.

In one embodiment, the image generation device includes a first image generation element that is configured to generate the imagery of the virtual environment for one eye of the user, and a second image generation element that is configured to generate the imagery of the virtual environment for another eye of the user.

In another embodiment, a method is provided. The method includes providing, to a HMD device having a FOV, imagery of a virtual environment including an out-the-window image component and a cockpit control image component that is registered to a cockpit control surface. Based on input from a hand track device, it is determined that a hand of a user is at a location in space that corresponds to a location within the FOV. The imagery of the virtual environment is altered to depict a virtual hand at the location within the FOV.

Those skilled in the art will appreciate the scope of the disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a block diagram of a simulator according to one embodiment;

FIG. 2 is a perspective view illustrating aspects of the simulator illustrated in FIG. 1 at a first instant in time according to one embodiment;

FIG. 3 illustrates example imagery of a virtual environment that may be provided to a head-mounted display (HMD) device at the first instant in time illustrated in FIG. 2;

FIG. 4 is a perspective view illustrating aspects of the simulator illustrated in FIG. 1 at a second instant in time;

FIG. 5 illustrates example imagery of the virtual environment that may be provided to the HMD device at the second instant in time illustrated in FIG. 4;

FIG. 6 is a perspective view illustrating aspects of a simulator according to another embodiment;

FIG. 7 illustrates example imagery of the virtual environment that corresponds to the simulator illustrated in FIG. 6; and

FIG. 8 is a flowchart of a method for providing imagery according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first image generation element” and “second image generation element,” and does not imply a priority, a type, an importance, or other attribute, unless otherwise stated herein.

The embodiments provide a domeless simulator that utilizes a head-wearable display, a head track device, and a hand track device to realistically simulate an out-the-window (OTW) display and an instrument control panel (such as a cockpit control panel) of a vehicle, such as an aircraft, to a user. Among other features, the embodiments visually depict in imagery movements of the user's hand manipulating virtual cockpit controls based on the physical movements of the user's hand in a real-world environment. The embodiments facilitate a simulator that has a relatively small footprint and that consumes substantially less power and has lower cooling requirements than conventional simulators.

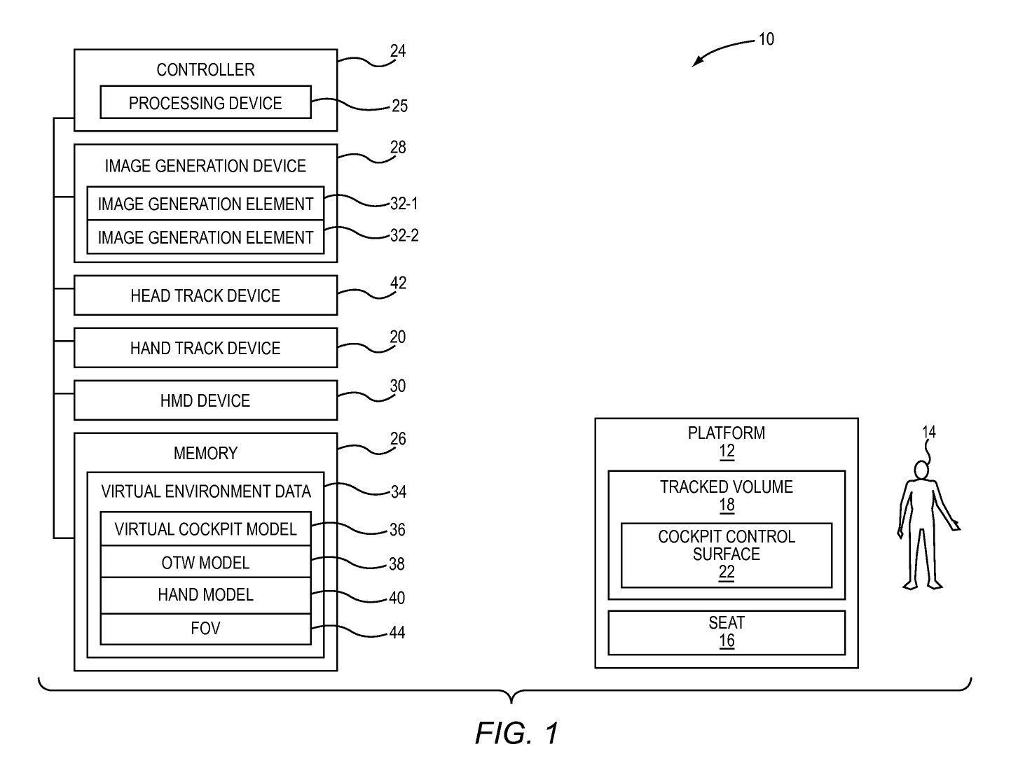

FIG. 1 is a block diagram of a simulator 10 according to one embodiment. The simulator 10 includes a platform 12 in which a user 14 is positioned. In one embodiment, during operation of the simulator 10 the user 14 may be located in a seat 16. While for purposes of illustration, the simulator 10 will be illustrated herein as an aircraft simulator, such as a military or commercial airplane or helicopter simulator, the embodiments are not limited to an aircraft simulator, and have applicability in simulations of a wide variety of apparatuses that include instrument control panels, including, for example, ground vehicles such as tanks, and the like.

The platform 12 includes a tracked volume 18 that comprises a volume of space that is tracked by a hand track device 20. As will be discussed in greater detail herein, the hand track device 20 tracks the movements and locations of one or both hands of the user 14. The tracked volume 18 also includes a cockpit control surface 22 that the user 14 may touch, or otherwise interact act with, during a simulation.

A controller 24 may include one or more processing devices 25 and a memory 26, and is responsible for overall coordination of the various functionalities described herein. An image generation device 28 generates imagery and provides the imagery to a head-mounted display (HMD) device 30. The HMD device 30 is a head-wearable apparatus that, in one embodiment, has an ultra-wide field-of-view, such as in excess of 100 degrees. In some embodiments, the HMD device 30 may comprise, or be substantially similar to, the HMD device described in U.S. Pat. No. 8,781,794 B2, entitled “METHODS AND SYSTEMS FOR CREATING FREE SPACE REFLECTIVE OPTICAL SURFACES,” filed on Aug. 17, 2011 and U.S. patent application Ser. No. 13/211,365, entitled “HEAD-MOUNTED DISPLAY APPARATUS EMPLOYING ONE OR MORE FRESNEL LENSES,” filed on Aug. 17, 2011, each of which is hereby incorporated by reference herein.

In one embodiment, the image generation device 28 includes a first image generation element 32-1 that is configured to generate imagery of the virtual environment for the right eye of the user 14, and a second image generation element 32-2 that is configured to generate imagery of the virtual environment for the left eye of the user 14. In one embodiment, the first and second image generation elements 32 comprise individual graphic processing units (GPUs). In some embodiments, the imagery provided to the eyes of the user 14 may be stereoscopic imagery, such that the user 14 experiences the virtual environment in a realistic three-dimensional (3D) sense.

The imagery of the virtual environment that is presented to the user 14 may be generated based on virtual environment data 34 that is maintained in the memory 26. The virtual environment data 34 may include a virtual cockpit model 36 that maintains information about a virtual cockpit that is registered to the cockpit control surface 22. Thus, when displayed to the user 14, the user 14 views a virtual cockpit that appears to be located relatively precisely at the same location as the real-world location of the cockpit control surface 22. The virtual cockpit model 36 may include information about a plurality of virtual cockpit controls, a current state of each virtual cockpit control, locations of relevant imagery associated with the virtual cockpit, and the like.

The virtual environment data 34 may also include an OTW model 38 that contains information about the environment that is external to the cockpit of the simulated vehicle, including, for example, information about objects in the external environment, the particular location of the simulated vehicle with respect to the external environment, information that identifies a portion of the external environment that is within a field of regard of the user 14, and the like. The virtual environment data 34 may also include a hand model 40 that provides information about a hand of the user 14. The hand model 40 may be based on data received from the hand track device 20, including, by way of non-limiting example, the location of the hand of the user 14 in X, Y, and Z coordinates in the tracked volume 18. In some embodiments, the hand model 40 may identify locations of individual fingers, and/or individual knuckles of the hand, depending on the particular capabilities of the hand track device 20. While only one hand model 40 is illustrated, in some embodiments the simulator 10 may keep track of both hands of the user 14, and in such embodiments, two hand models 40 may be utilized.

A head track device 42 provides head track data that comprises information about the orientation and location of the head of the user 14. In one embodiment, the head track device 42 may be coupled to the HMD device 30. The head track device 42 may comprise, for example, an inertial measurement unit (IMU) that continually, over the duration of a simulation, provides relatively precise orientation information associated with movements of the head of the user 14. The head track device 42 may be positioned at a known location with respect to a reference location, such as the mid-point between the two eyes of the user 14, such that the orientation information can be used to determine relatively precisely where the user 14 is looking. The controller 24 may utilize the information received from the head track device 42 to maintain an instantaneous field-of-view (FOV) 44 of the HMD device 30. The image generation device 28 may utilize the FOV 44 in conjunction with the virtual cockpit model 36, OTW model 38, and hand model 40 to determine precisely which imagery associated with the virtual environment should be rendered and provided to the HMD device 30 at a relatively high rate, such as 30 or 60 times per second. Thus, as the head track device 42 detects movements of the head of the user 14, the controller 24 continuously determines and updates the FOV 44, and the image generation device 28 continuously alters the imagery provided to the HMD device 30 in synchronicity with the changing FOV 44. Some embodiments allow the user 14 to have a complete 360 degree viewing area such that irrespective of where the user 14 looks, the user 14 experiences similar visuals to that which would be seen by the user 14 in the aircraft being simulated. Thus, for example, during the simulation the user 14 may look over a shoulder through a simulated cockpit window and see one or more other aircraft. Moreover, when the hand model 40 indicates that the hand of the user 14 is at a location within the tracked volume 18 that is within the FOV 44 of the HMD device 30, the image generation device 28 generates imagery that depicts a virtual hand at a location in the virtual environment that corresponds to the location of the hand of the user 14 in the real world.

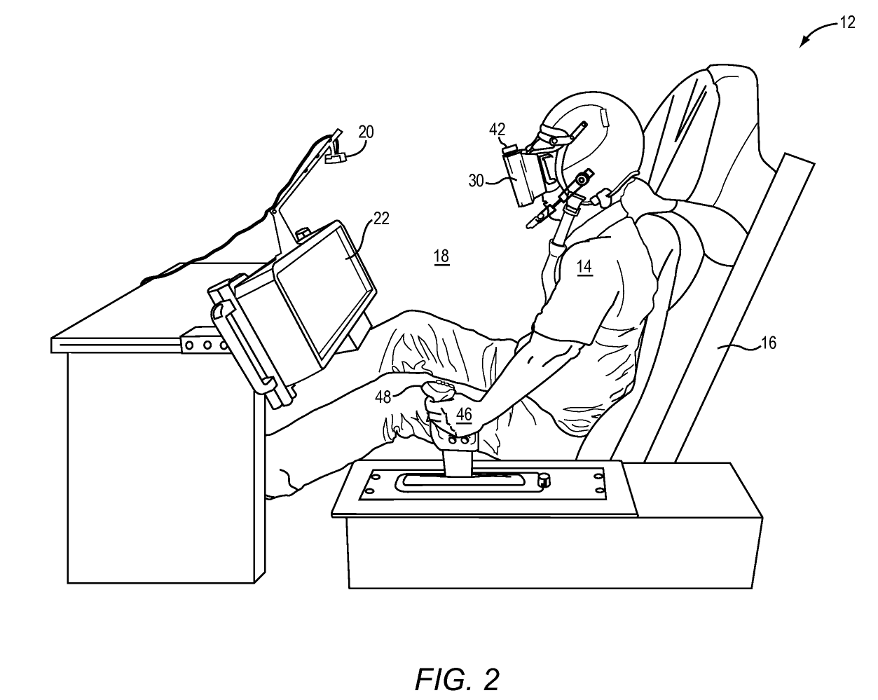

FIG. 2 is a perspective view illustrating aspects of the simulator 10 according to one embodiment, at a first instant in time. The user 14 is seated in the seat 16 of the platform 12. A left hand 46 of the user 14 is illustrated grasping a hardware control 48 associated with flight of the simulated aircraft. The head track device 42 identifies a current location and orientation of the head of the user 14 which may be utilized to determine the current FOV 44 (FIG. 1) of the HMD device 30. If the left hand 46 is not within the FOV 44, the imagery provided to the user 14 will not depict the left hand 46. The cockpit control surface 22 may comprise any desired hardened surface, such as a laminate, wood, glass, or the like. In some embodiments, the cockpit control surface 22 may be relatively inexpensive, and simply provide a relatively hard surface that provides tactile feedback when contacted by a digit of the left hand 46. Because the cockpit control surface 22 is not viewed by the user 14 during the simulation, in some embodiments the cockpit control surface 22 can be devoid of labels, indicia, or other visual characteristics of the cockpit being simulated, which can further reduce costs associated with the cockpit control surface 22. In some embodiments, as discussed in greater detail herein, the cockpit control surface 22 may provide movable switches, dials, touch screen surfaces, and the like, to provide tactile feedback to the user 14 analogous or identical to that of the cockpit of the particular aircraft being simulated. In some embodiments, the cockpit control surface 22 can be a complete mockup of the cockpit of the particular aircraft being simulated. In other embodiments, the cockpit control surface 22 may map to only a particular portion of a cockpit being simulated. In some embodiments, the cockpit control surface 22 may operate in conjunction with a device worn by the user 14 that provides tactile feedback when the left hand 46 is detected at the appropriate location, such as a glove that vibrates or otherwise provides feedback that simulates that which the user 14 would sense if in the aircraft being simulated. The cockpit control surface 22 may be mounted in a manner that permits substitution with different cockpit control surfaces 22 depending on the particular aircraft being simulated. Thus, during a first simulation a first user 14 may utilize a first cockpit control surface 22 that provides tactile feedback analogous to a cockpit in a first commercial aircraft. After the first simulation ends, the first cockpit control surface 22 may be substituted with a second cockpit control surface 22 that provides tactile feedback analogous to a cockpit in a second commercial aircraft.

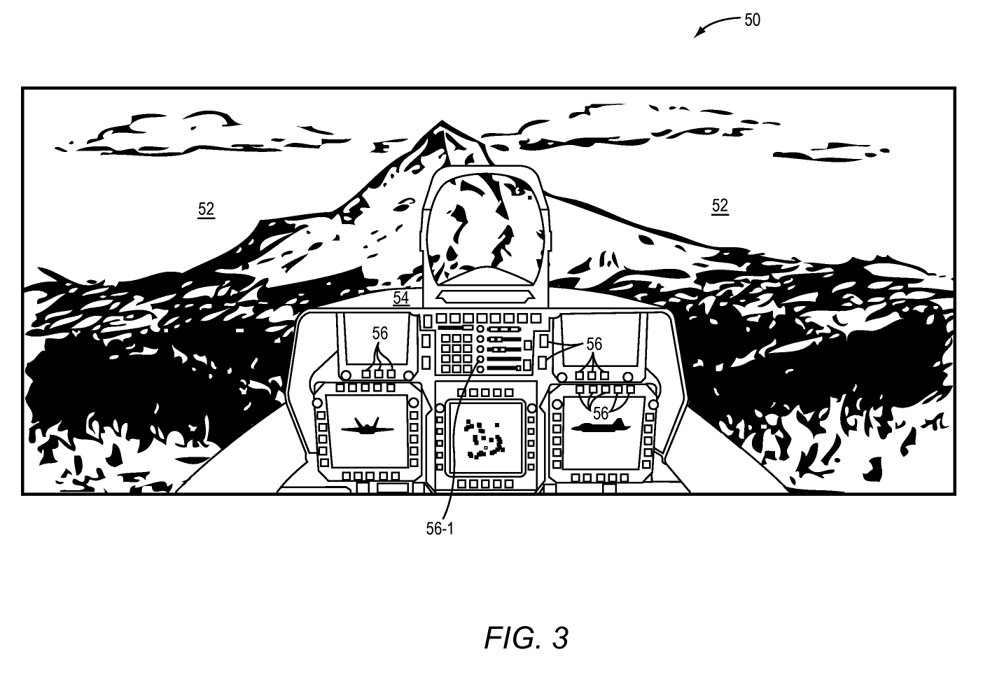

FIG. 3 illustrates example imagery 50 of a virtual environment that may be provided to the HMD device 30 by the image generation device 28 at the first instant in time illustrated in FIG. 2. The imagery 50 includes an OTW image component 52 that depicts the environment that is external to the simulated aircraft and that can be viewed by the user 14 given the FOV 44 at that instant in time. The imagery 50 also includes a cockpit control image component 54 that depicts a virtual cockpit that preferably appears substantially identical to the aircraft being simulated. The cockpit control image component 54 depicts a plurality of virtual cockpit controls 56, 56-1, only some of which are labelled due to space constraints. The cockpit control image component 54 is relatively precisely registered to the cockpit control surface 22 (FIG. 2), such that the perceived location of any particular virtual cockpit control 56 is within 1/10 of an inch of a predetermined location on the cockpit control surface 22. This registration may be based on precise measurements made of the platform 12, distances between the seat 16 and the cockpit control surface 22, the distance between a common-sized user 14 and the intersection of the cockpit control surface 22, and the like.

The imagery 50 is generated by the image generation device 28 (FIG. 1) based on the state of the virtual environment data 34 at that particular instant in time. As noted above, the current FOV 44 may be utilized to determine relatively precisely where the user 14 is looking, and based on this information, the virtual cockpit model 36, OTW model 38, and hand model 40 may be “intersected” with the FOV 44 to determine those objects and imagery that would be within the FOV 44. Note that, in this example, the left hand 46 is outside the FOV 44 and thus is not depicted in the imagery 50.

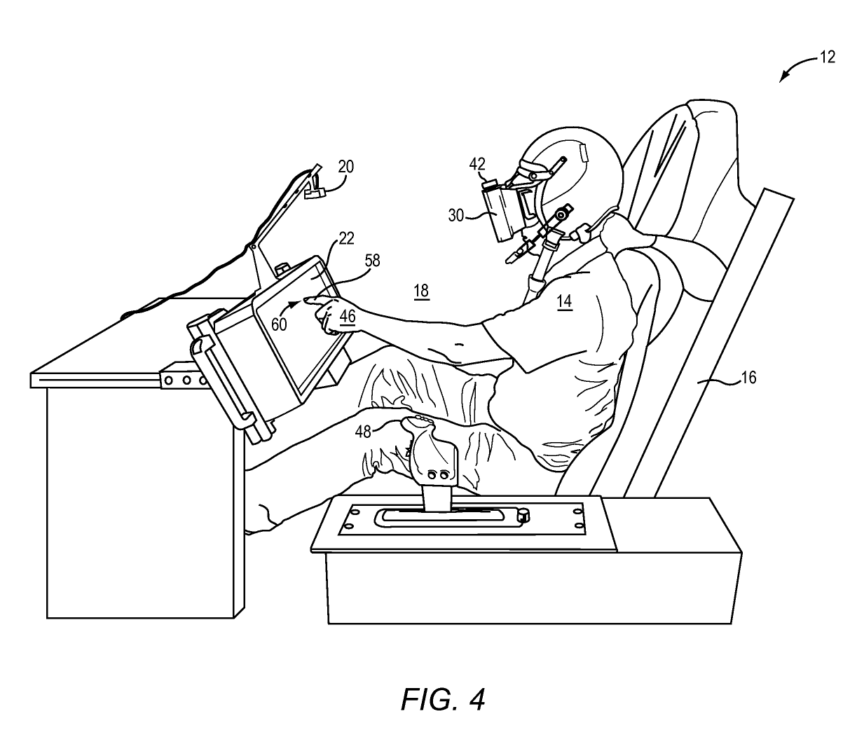

FIG. 4 is a perspective view illustrating aspects of the simulator 10 at a second instant in time. The user 14 has moved the left hand 46 from the hardware control 48 to contact the cockpit control surface 22 with a digit 58 at a particular contact location 60 of the cockpit control surface 22. As discussed in greater detail below, the controller 24 can correlate the contact location 60 with a particular virtual cockpit control 56, and cause the image generation device 28 to depict imagery that depicts contact of the virtual cockpit control 56 with a virtual hand. As the left hand 46 moves, the hand track device 20 detects the movement and provides location information, which is used to continuously update the hand model 40, to the controller 24. The hand track device 20 may comprise any suitable device that is capable of tracking hand movements in a tracked volume. In one embodiment, the hand track device 20 comprises a Leap Motion Controller, available from Leap Motion, Inc., 333 Bryant Street, Suite LL150, San Francisco, Calif. 94107. While the hand track device 20 is illustrated as a wireless device that monitors the location of the hand 46 without physical contact with the hand 46, in other embodiments, other hand tracking devices may be utilized, such as a glove with reflective strips, or a glove containing one or more IMU's that provide data identifying the particular location of individual digits of the hand 46.

When the hand model 40 indicates that the hand 46 has moved within the FOV 44 of the HMD device 30, the image generation device 28 inserts a virtual hand into the imagery of the virtual environment that is provided to the HMD device 30 at a virtual location that corresponds to the sensed location of the hand 46 in the tracked volume 18. As the hand 46 moves within the tracked volume 18, the image generation device 28 generates imagery that depicts the virtual hand moving with the respect to the FOV 44 in correspondence with the sensed locations of the hand 46.

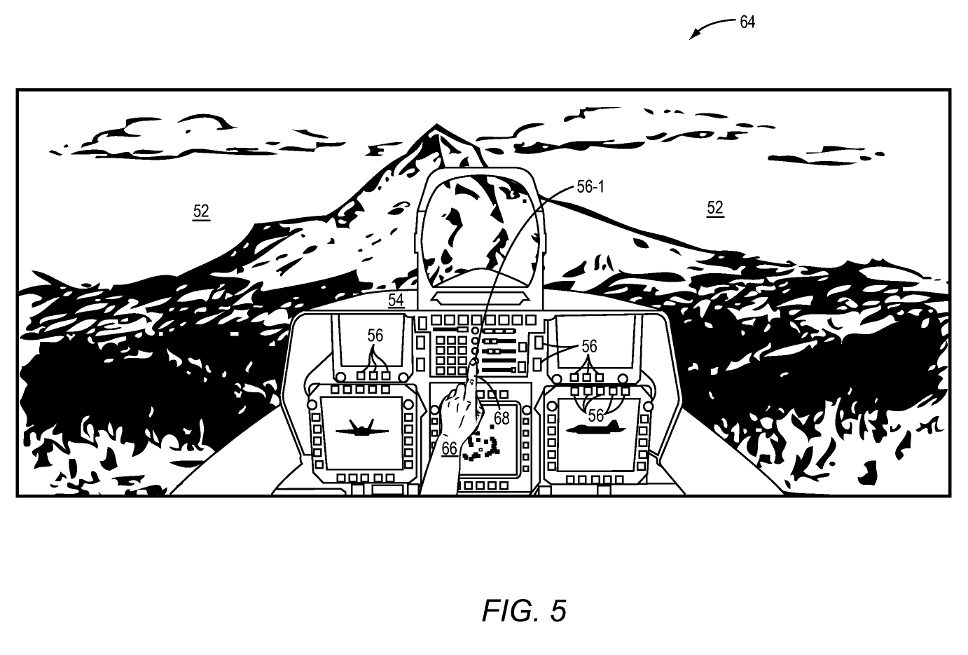

FIG. 5 illustrates example imagery 64 of the virtual environment that may be provided to the HMD device 30 by the image generation device 28 at the second instant in time illustrated in FIG. 4. Note that the imagery 64 includes a virtual hand 66 and a virtual digit 68 that corresponds to the hand 46 and the digit 58, respectively, of the user 14. Based on the contact location 60 of the cockpit control surface 22 (FIG. 4), the imagery 64 depicts the virtual digit 68 contacting the virtual cockpit control 56-1. Thus, the user 14 feels tactile input as the digit 58 contacts the cockpit control surface 22 that corresponds visually with the precise moment that the virtual digit 68 touches the virtual cockpit control 56-1. Because the cockpit control surface 22 is not viewed by the user 14, the cockpit control surface 22 may simply comprise a relatively inexpensive flat surface, devoid of any labeling or indicia. The tactile input experienced by the user 14 when touching the virtual cockpit control 56-1 may be substantially similar to, or identical to, that of the cockpit being simulated.

The selection or activation of a virtual cockpit control 56 may, depending on the simulated function of the virtual cockpit control 56, alter a vehicle motion characteristic of the simulated vehicle, such as altitude, velocity, or direction. In response to the altered vehicle motion characteristic, the virtual environment data 34 may change, such that the imagery provided to the HMD device 30 may change. For example, if selection of the virtual cockpit control 56 caused the roll, pitch, or yaw of the simulated aircraft to change, the image generation device 28 generates imagery that corresponds to such changed roll, pitch, or yaw.

While for purposes of illustration only a single user 14 has been discussed, in some embodiments the simulator 10 maintains multiple FOVs 44 for multiple users 14 in a simulation, such as, for example, a pilot and a weapon systems officer (WSO). In such embodiments, each user 14 may have a corresponding FOV 44 maintained in the virtual environment data 34, and a corresponding hand model 40. The image generation device 28 may include additional image generation elements 32 that are configured to generate imagery for each user 14 in the simulation based on the virtual environment data 34. The WSO may also have a separate cockpit control surface 22 (not illustrated) that is registered to a cockpit control image component seen by the WSO, and which provides tactile feedback substantially similar to that which the WSO would experience in the cockpit of the aircraft being simulated.

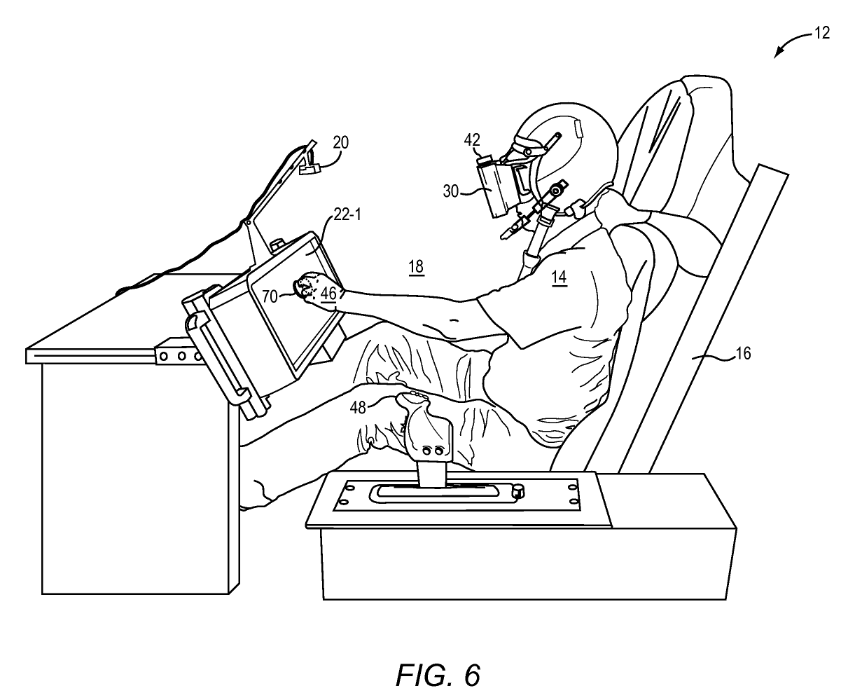

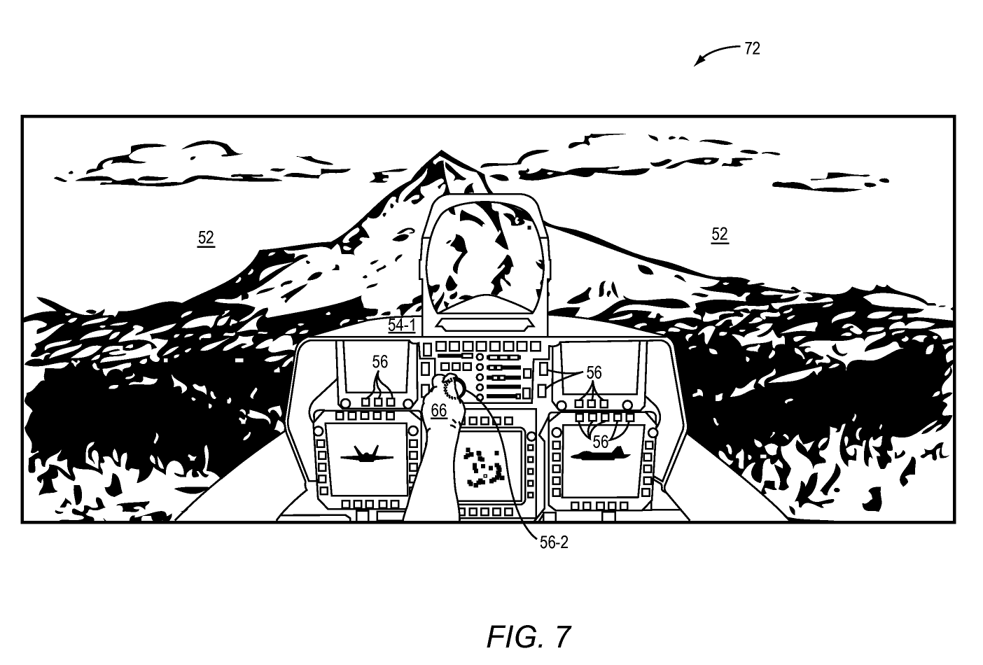

FIG. 6 is a perspective view illustrating aspects of a simulator according to another embodiment. In this embodiment, a cockpit control surface 22-1 includes a physical control, in this example a knob 70. Except as otherwise noted herein, the cockpit control surface 22-1 may be substantially similar to the cockpit control surface 22 discussed above. The knob 70 is illustrated as being grasped by the left hand 46 of the user 14. FIG. 7 illustrates example imagery 72 of the virtual environment that corresponds to the simulator illustrated in FIG. 6 at the same instant of time and which is provided to the HMD device 30. The controller 24 has correlated the location of the left hand 46 illustrated in FIG. 6 with a virtual cockpit control 56-2 in a cockpit control image component 54-1, and thus the imagery 72 illustrates the virtual hand 66 rotating the virtual cockpit control 56-2. In this manner, the user 14 receives tactile feedback from the cockpit control surface 22-1 that would be expected by the user 14 if the virtual cockpit control 56-2 could be physically grasped and rotated.

As discussed above, while the cockpit control surface 22-1 illustrated in FIG. 6 is shown with only a single knob 70, the cockpit control surface 22-1 could comprise any number of physical controls, such as knobs, rocker switches, toggle switches, paddle switches, rotary switches, slide switches, resilient surfaces that simulate feedback associated with a touch screen surface, and the like, that correspond precisely to a particular cockpit being simulated. In some embodiments, the cockpit control surface 22 is designed to be replaceable in the platform 12, such that different cockpit control surfaces 22 may be utilized depending on the particular vehicle being simulated.

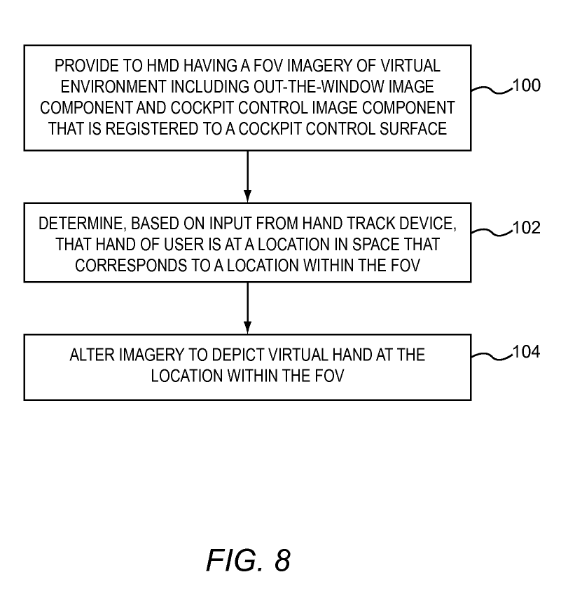

FIG. 8 is a flowchart of a method for providing imagery according to one embodiment. Initially, imagery of a virtual environment including an OTW image component and a cockpit control image component that is registered to a cockpit control surface is provided to a HMD device having a FOV (block 100). Based on input from a hand track device, it is determined that a hand of the user is at a location in space that corresponds to a location within the FOV (block 102). The imagery is altered to depict a virtual hand at the location within the FOV (block 104).

Referring again to FIG. 1, all or a portion of the embodiments may be implemented as a computer program product stored on a transitory or non-transitory computer-usable or computer-readable storage medium, which includes complex programming instructions, such as complex computer-readable program code, configured to cause the controller 24 to carry out the functionality described herein. Thus, the computer-readable program code can comprise software instructions for implementing the functionality of the embodiments described herein when executed on the processing device 25.

Among other features, the embodiments provide a relatively low-cost, full-motion and wide field-of-view simulator that realistically simulates vehicles, such as aircraft, including the cockpit control surfaces of such vehicles, without requiring the cost and space associated with a domed simulator. Further, some embodiments provide cockpit control surface feedback identical to that of the vehicle being simulated, without the expense of full mockup cockpit control surfaces, and can utilize replaceable cockpit control surfaces such that any number of different vehicles may be realistically simulated by simply swapping one cockpit control surface with another.

Those skilled in the art will recognize improvements and modifications to the preferred embodiments of the disclosure. All such improvements and modifications are considered within the scope of the concepts disclosed herein and the claims that follow.

What is claimed is:

1. A simulator system comprising:
a head-mounted display (HMD) device having a field-of-view (FOV);
a cockpit control surface;
an image generation device coupled to the HMD device and configured to generate imagery of a virtual environment including an out-the-window image component and a cockpit control image component that is registered to the cockpit control surface;
a hand track device configured to sense a location of a hand of a user; and
a controller coupled to the hand track device and configured to determine the location of the hand of the user with respect to the FOV.

2. The simulator system of claim 1, wherein the controller is further configured to cause the image generation device to insert a virtual hand into the imagery of the virtual environment at a virtual location that corresponds to a sensed location of the hand of the user.

3. The simulator system of claim 2, wherein the controller is further configured to:
determine, based on the hand track device, a contact location on the cockpit control surface of the hand of the user;
correlate the contact location with a virtual cockpit control of a plurality of virtual cockpit controls depicted in the cockpit control image component; and
cause the image generation device to generate imagery depicting contact of the virtual cockpit control with the virtual hand.

4. The simulator of claim 3, wherein the controller is further configured to alter a vehicle motion characteristic based on the virtual cockpit control.

5. The simulator of claim 4, wherein the vehicle motion characteristic comprises one of altitude, velocity, and direction.

6. The simulator of claim 4, wherein the controller is further configured to cause the image generation device to alter the imagery of the virtual environment in response to altering the vehicle motion characteristic.

7. The simulator of claim 1, further comprising a head track device, and wherein, based on head track data received from the head track device, the controller is further configured to continuously determine the FOV of the HMD device.

8. The simulator of claim 7, wherein the controller is configured to alter the imagery of the virtual environment in synchronization with a change in the FOV of the HMD device.

9. The simulator of claim 1, wherein, over a period of time, based on the hand track device, the controller is further configured to cause the image generation device to move a virtual hand with respect to the FOV in correspondence with a plurality of sensed locations of the hand of the user over the period of time.

10. The simulator of claim 1, wherein the cockpit control surface comprises no labelling or indicia.

11. The simulator of claim 1, wherein the image generation device comprises a first image generation element configured to generate the imagery of the virtual environment for one eye of the user, and a second image generation element configured to generate the imagery of the virtual environment for another eye of the user.

12. A method of providing a simulation, comprising:
providing, to a head-mounted display (HMD) device having a field-of-view (FOV), imagery of a virtual environment including an out-the-window image component and a cockpit control image component that is registered to a cockpit control surface;
determining, based on input from a hand track device, that a hand of a user is at a location in space that corresponds to a location within the FOV; and
altering the imagery of the virtual environment to depict a virtual hand at the location within the FOV.

13. The method of claim 12, further comprising:
determining, based on the input from the hand track device, a contact location on the cockpit control surface of the hand of the user;
correlating the contact location with a virtual cockpit control of a plurality of virtual cockpit controls depicted in the cockpit control image component; and
altering the imagery of the virtual environment to depict movement of the virtual cockpit control by the virtual hand.

14. The method of claim 13, further comprising altering a vehicle motion characteristic based on the virtual cockpit control.

15. The method of claim 14, wherein the vehicle motion characteristic comprises one of altitude, velocity, and direction.

16. The method of claim 14, further comprising altering the imagery of the virtual environment in response to altering the vehicle motion characteristic.

17. The method of claim 12, further comprising receiving head track data from a head track device, and continuously determining a FOV of the HMD device based on the head track data.

18. The method of claim 17, further comprising altering the imagery of the virtual environment in synchronization with a change in the FOV of the HMD device.

19. The method of claim 12, further comprising, over a period of time, based on the hand track device, generating imagery that depicts the virtual hand moving with respect to the FOV in correspondence with a plurality of sensed locations of the hand of the user over the period of time.
